(19) United States
(12) Patent Application Publication
(10) Pub. No.: US 2010/0218631 A1
(43) Pub. Date: Sep. 2, 2010

(54) QUICK-RELEASE GEAR ASSEMBLY

(75) Inventors: Shih-Hsiung HUANG, Taichung County (TW); Li-Jung CHANG, Taichung County (TW); Min-Hui TSAI, Taichung County (TW); Tien-Hsiang LIN, Taichung County (TW); Ching-Ho HUANG, Changhua County (TW); Shih-Chieh HUANG, Taichung County (TW); Shin-Yi CHEN, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: GENERAL PLASTIC INDUSTRIAL CO., LTD., Wu-Chi Town (TW)

(21) Appl. No.: 12/472,598

(22) Filed: May 27, 2009

(30) Foreign Application Priority Data
Mar. 2, 2009 (TW) 98106758

(51) Int. Cl. F16H 55/12

(52) U.S. Cl. 74/405

(57) ABSTRACT

A quick-release gear assembly includes a retaining base having a base body and an elastic arm extending from the base body and provided at a distal end thereof with a first locating portion, and a gear having a gear body and a second locating portion located at the gear body and detachably engaged with the first locating portion of the retaining base for fastening the gear to the retaining base. Accordingly, the gear can be disassembled from the retaining base conveniently by disengaging the second locating portion of the gear from the first locating portion of the retaining base for the purpose of quick replacement of the gear.

### BACKGROUND OF THE INVENTION

1. Field of the Invention

The present invention relates generally to gears, and more specifically to a quick-release gear assembly.

2. Description of the Related Art

FIG. 1 shows a conventional gear 10 mounted on a rotary shaft 3 of a housing 2 of a toner cartridge 1, and provided with two opposite driving portions 12 that are drivable by a mating member (not shown) of an electrical imaging apparatus (not shown) for transmitting power to other gears.

To meet the practical requirement, the driving portions 12 of the gear 10 must be made in various patterns for cooperation with different types of the electrical imaging apparatuses. However, the gear 10 is undetachably mounted to the shaft 3, such that the gear 10 or the shaft 3 may be damaged if the gear 10 is forced to be disassembled from the shaft 3. In order to eliminate the aforesaid drawback, a number of the gears 10 having different shapes or number of the driving portions 12 can be mounted to different toner cartridges 1 respectively, and then the toner cartridges 1 can be respectively connected with different types of the electrical imaging apparatus according to different types of the driving portions 12. However, it is troublesome and inconvenient for the conventional toner cartridge to be optionally connected with the matchable electric imaging apparatus.

### SUMMARY OF THE INVENTION

The present invention has been accomplished in view of the above-noted circumstances. It is one objective of the present invention to provide a quick-release gear assembly, which allows assembly and disassembly of a gear in a quick and easy manner within narrow space.

To achieve this objective of the present invention, the quick-release gear assembly comprises a retaining base and a gear. The retaining base includes a base body and an elastic arm extending outward from the base body and provided at a distal end thereof with a first locating portion. The gear includes a gear body and a second locating portion located at the gear body and detachably engaged with the first locating portion of the retaining base for mounting the gear to the retaining base.

By means of disengaging the second locating portion of the gear from the first locating portion of the retaining base, the gear can be detached from the retaining base for replacement or maintenance.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention, wherein:

FIG. 1 is a perspective view of a gear according to the prior art;

FIG. 2 is an end view of a housing of a toner cartridge, showing that the conventional gears are mounted to the housing of the toner cartridge;

FIG. 3 is a perspective view of a gear assembly according to a preferred embodiment of the prevent invention;

FIG. 4 is an exploded view of the gear assembly according to the preferred embodiment of the present invention;

FIG. 5 is a cutaway view of the gear assembly according to the preferred embodiment of the prevent invention, showing that the gear is not engaged with the retaining base;

FIG. 6 is similar to FIG. 5, showing that the gear is engaged with the retaining base; and

FIG. 7 is an end view of a housing of a toner cartridge, showing the gear assembly of the present invention is mounted to the housing of the toner cartridge.

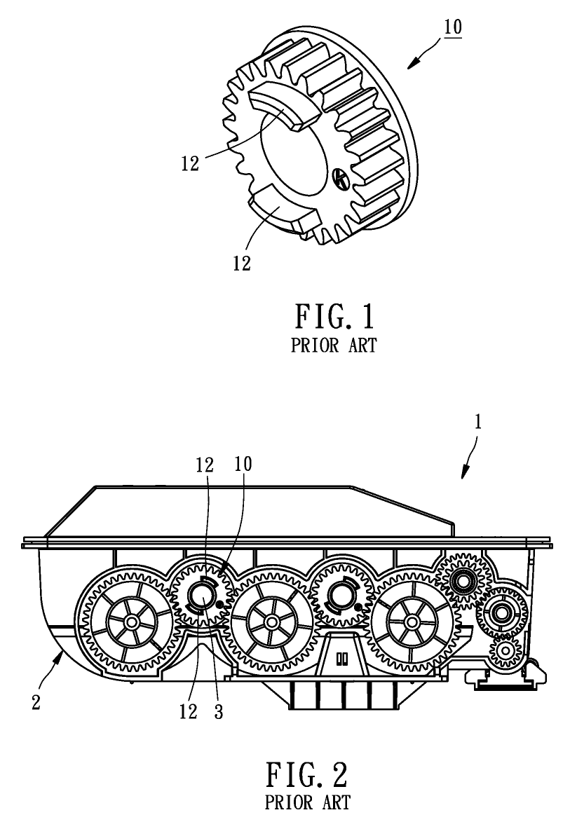

### DETAILED DESCRIPTION OF THE INVENTION

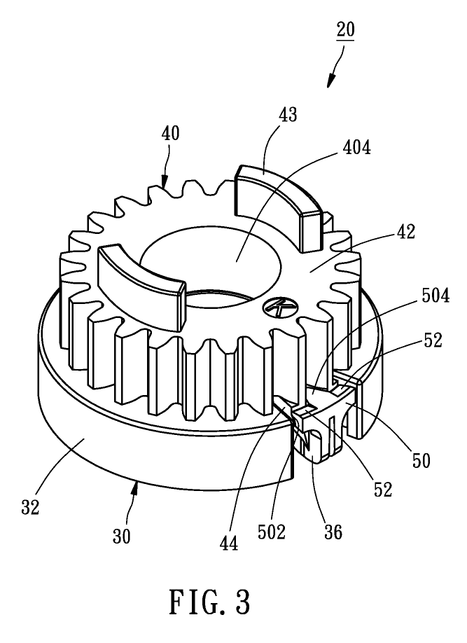

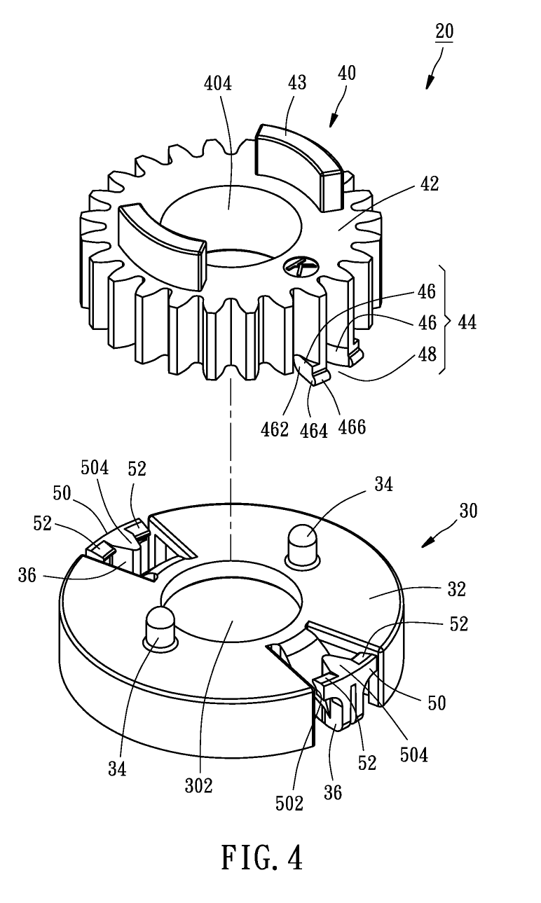

As shown in FIGS. 3 and 4, a quick-release gear assembly 20 in accordance with a preferred embodiment of the present invention comprises a retaining base 30 and a gear 40.

The retaining base 30 includes a base body 32 having a first axial hole 302 at a center thereof, two posts 34 protruding upwards from a top side of the base body 32 along an axial direction of the base body 32, and two elastic arms 36 extending oppositely from the base body 32 along a radial direction of the base body 32. Each of the elastic arms 36 has a first locating portion 50 and two guide surfaces 52 at a distal end thereof. The first locating portion 50 has two recesses 502 respectively provided with an arc-shaped periphery, and a block 504 located between the recesses 502.

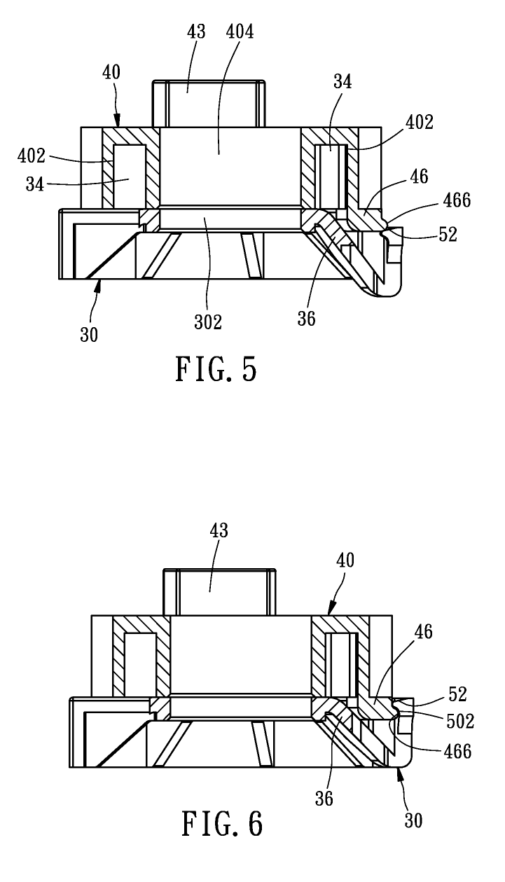

The gear 40 includes a gear body 42 and two second locating portions 44 each having two hooks 46 and a notch 48 between the hooks 46. The hooks 46 each have an axial section 462 and a radial section 464. The axial section 462 extends downwards along an axial direction of the gear body 42. The radial section 464 extends frontward from the axial section 462 along a radial direction of the gear body 42, having an arc-shaped surface 466. Further, as shown in FIG. 5, the gear 40 includes two locating holes 402 and a second axial hole 404. The two locating holes 402 are recessed axially from a bottom side of the gear body 42 for insertion of the posts 34 of the retaining base 30. The second axial hole 404 is formed at a center of the gear body 42 for communication with the first axial hole 302 of the retaining base 30.

When the gear assembly 20 is mounted to the retaining base 30, the posts 34 of the retaining base 30 are aligned with and then inserted into the two locating holes 402 respectively. In the meantime, the hooks 46 of the second locating portions 44 of the gear 40 abut against the guide surfaces 52 of the elastic arms 36 of the retaining base 30 via the arc-shaped surfaces 466, as shown in FIG. 5. Next, a user can press the gear 40 to force the guide surfaces 52 of the retaining base 30 to be pressed by the arc-shaped surfaces 466 of the hooks 46 of the gear 40, causing the elastic arms 36 to be gradually deformed. Once the arc-shaped surfaces 466 of the hooks 46 of the gear 40 are staggered with the guide surfaces 52 of the retaining base 30, the elastic arms 36 can respectively generate a resilience to enable the hooks 46 of the second locating portions 44 of the gear 40 to be engaged with the recesses 502 of the first locating portions 50 of the retaining base 30 and to abut against the arc-shaped periphery of the recesses 502 via the arc-shaped surfaces 466, and enable the blocks 504 of the first locating portions 50 of the retaining base 30 to be engaged with the notches 48 of the second locating portions 44 of the gear 40, as shown in FIGS. 3 and 6, thereby completing the assembly of the gear assembly 20.

When disassembling the gear 40 from the retaining base 30, the user can press the first locating portions 50 of the retaining base 30 to result in the elastic deformation of the elastic arms 36 such that the hooks 46 of the second locating portions 44 of the gear 40 are gradually disengaged from the recesses 502 of the first locating portions 50 of the retaining base 30. As soon as the hooks 46 of the gear 40 are disengaged from the recesses 502 of the retaining base 30, the guide surfaces 52 of the elastic arms 36 can push upwards the arc-shaped surfaces 466 of the hooks 46 of the gear 40 owing to the resilience of the elastic arms 36 to detach the gear 40 from the retaining base 30.

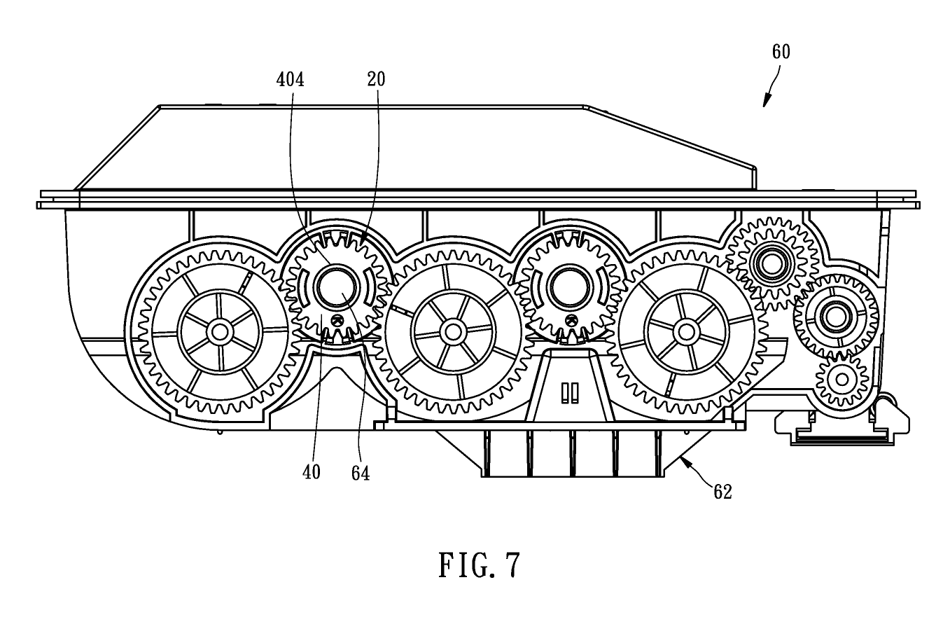

As shown in FIG. 7, the gear assembly 20 of the present invention is mounted to a housing 62 of a toner cartridge 60 in such a way that a rotary shaft 64 of the housing 62 of the toner cartridge 60 is inserted through the first axial hole 302 of the retaining base 30 and the second axial hole 404 of the gear 40.

When replacing the gear 40, the user can press the first locating portions 50 of the retaining base 30 by using a tool to cause the deformation of the elastic arms 36 and to further detach the second locating portions 44 of the gear 40 from the first locating portions 50 of the retaining base 30, thus easily completing the disassembly of the gear 40 even though it is done in narrow space. Accordingly, since the gear 40 is assembled and disassembled in a quick and convenient manner, the toner cartridge 60 can be cooperated with different types of electrical imaging apparatuses (not shown) by replacing the gears 40 having different driving portions 43, thus enhancing the convenience in installing the toner cartridge 60 into the electrical imaging apparatus and reducing installation time of the toner cartridge 60.

The gear assembly can be made with various kinds of design on the basis of the spirit of the present invention. For example, the retaining base can be provided with at least one elastic arm. Further, the first locating portion of the retaining base can have at least one recess, and the second portion of the gear can have at least one hook to match the recess. Furthermore, the gear assembly of the present invention is not only used in the toner cartridge, but also applied to a machine needing a transmission gear assembly, such as a fax machine or copy machine.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A quick-release gear assembly comprising:
a retaining base having a base body and an elastic arm extending from the base body and provided at a distal end thereof with a first locating portion; and
a gear having a gear body and a second locating portion located at the gear body and detachably engaged with the first locating portion of the retaining base for fastening the gear to the retaining base.

2. The gear assembly as claimed in claim 1, wherein the elastic arm extends along a radial direction of the base body.

3. The gear assembly as claimed in claim 1, wherein the first locating portion of the retaining base has a recess, and the second locating portion of the gear has a hook engaged with the recess.

4. The gear assembly as claimed in claim 3, wherein the hook has an axial section extending along an axial direction of the gear body, and a radial section extending from the axial section along a radial direction of the gear body.

5. The gear assembly as claimed in claim 4, wherein the radial section of the hook has an arc-shaped surface abutting against the recess of the first locating portion of the retaining base.

6. The gear assembly as claimed in claim 3, wherein the recess of the first locating portion of the retaining base has an arc-shaped periphery.

7. The gear assembly as claimed in claim 3, wherein the second locating portion of the gear has two of said hooks and a notch located between the hooks, and the first locating portion of the retaining base has two of said recesses and a block located between the recesses and engaged with the notch.

8. The gear assembly as claimed in claim 1, wherein the elastic arm has a guide surface at a distal end thereof.

9. The gear assembly as claimed in claim 1, wherein the gear has a locating hole, and the retaining base has a post inserted into the locating hole.
